(19) United States
(12) Patent Application Publication
(10) Pub. No.: US 2026/0214349 A1
(43) Pub. Date: Jul. 23, 2026

(54) PHOTODETECTION APPARATUS AND ELECTRONIC DEVICE

(71) Applicant: SONY SEMICONDUCTOR SOLUTIONS CORPORATION, KANAGAWA (JP)

(72) Inventor: YASUJI IKEDA, KANAGAWA (JP)

(21) Appl. No.: 19/158,139

(22) PCT Filed: Jan. 12, 2024
(86) PCT No.: PCT/JP2024/000633

§ 371 Date: Aug. 20, 2025

(30) Foreign Application Priority Data
Mar. 8, 2023 (JP) 2023-035921

(51) Int. Cl. H04N 25/53; G01J 1/44; H04N 25/767; H04N 25/768; H04N 25/78

(52) U.S. Cl. CPC H04N 25/53; G01J 1/44; H04N 25/767; H04N 25/768; H04N 25/78; G01J 2001/4466

(57) ABSTRACT

In a photodetection apparatus that performs TDI processing, multistage TDI processing is further achieved.

A photodetection apparatus according to the present technology includes: a pixel array unit in which pixel circuits each including a photon detection unit and a counter are arranged in a matrix and which constitutes a pixel unit with N stages (N is an integer) as one unit for each pixel column; a holding array unit which is provided outside the pixel array unit and holds a count value read from the pixel unit; and a control unit which reads the count value for each pixel unit with M (M is an integer) pixel units as a unit. The holding array unit includes: (M-1) holding units each having a holding unit at N stages that holds a count value read from one pixel unit of the M pixel units; and (M-1) addition circuits that add a held value of a holding unit at a final stage in the holding unit at the N stages and a count value read from a pixel unit of a next stage of the one pixel unit.

### TECHNICAL FIELD

The present technology relates to a photodetection apparatus. Specifically, the present invention relates to a photodetection apparatus and an electronic device that perform time delay integration processing.

### BACKGROUND ART

Conventionally, a TDI sensor that performs time delay integration (TDI) processing has been used in the field of factory automation (FA), the field of aerial photographing, or the field of medical care. This TDI sensor is a sensor that performs TDI processing of integrating the amount of charge while shifting time in accordance with the moving speed of the subject. For example, in each pixel circuit arranged in a matrix, there has been proposed an imaging apparatus that writes a count value of a counter as an initial value to a counter in a next stage (next row) via a latch unit, and adds information obtained from a light pulse response unit in response to light incidence to the initial value to realize TDI processing (see, for example, Patent Document 1).

### CITATION LIST

### Patent Document

Patent Document 1: WO 2023/276299 A

### SUMMARY OF THE INVENTION

### Problems to be Solved by the Invention

In the above-described conventional technique, by providing the latch unit between two counters adjacent in the column direction by the TDI processing, transfer of image data can be realized with simple control. However, in the above-described imaging apparatus, since the latch unit is provided between the two counters, and the count value of the counter is shifted and added in the pixel array unit, the circuit area in the pixel array unit increases. As a result, since the number of counters that can be arranged in the pixel array unit is limited, it is difficult to further multistage the TDI processing.

The present technology has been made in view of such a situation, and it is an object of the present technology to achieve more multistage TDI processing in a photodetection apparatus that performs TDI processing.

### Solutions to Problems

The present technology has been made to solve the above-described problems, and a first aspect of the present technology is a photodetection apparatus including: a pixel array unit in which pixel circuits each including a photon detection unit that generates a pulse signal in response to incidence of photons and a counter that counts the pulse signal generated by the photon detection unit are arranged in a matrix form, and the pixel circuits constitute a pixel unit with N stages (N is an integer) as one unit for each pixel column; a holding array unit that is provided outside the pixel array unit and holds a count value of the counter read from the pixel unit; and a control unit that performs a shift operation of writing a count value of the counter in a preceding stage to the counter in a next stage before exposure of a next line is started in the pixel unit and reads a count value of the counter for each pixel unit in units of M (M is an integer) pixel units from the pixel array unit to the holding array unit, in which the holding array unit includes: (M-1) holding units each of which is provided corresponding to a pixel column of the pixel array unit and includes a holding unit at N stages that holds a count value of the counter read from one pixel unit of the M pixel units; and (M-1) addition circuits that add a held value of a holding unit at a final stage in the holding unit at the N stages and a count value of the counter read from a pixel unit at a next stage of the one pixel unit. As a result, since the circuit area in the pixel array unit can be reduced, the TDI processing can be made multistage, and the dynamic range can be expanded.

Furthermore, in the first aspect, the bit length of the counter in each stage of the pixel array unit may be a bit length set on the basis of the maximum value of the counter in the first stage and the number of stages in the one unit. This brings about an effect that one unit can be formed with a smaller area.

Furthermore, in the first aspect, a readout holding circuit that holds a count value of the counter read under the control of the control unit may be included for each pixel unit of the M pixel units, and the control unit may sequentially read the count value of the counter from the readout holding circuit. As a result, it is sufficient to complete the reading of the count value held in the readout holding circuit during the exposure period in which the shift is performed in each stage, and thus, it is possible to secure the reading time.

Furthermore, in the first aspect, a common reading line may be provided for each pixel unit of the M pixel units, and the control unit may sequentially read out the count value of the counter from the readout holding circuit of each pixel unit of the M pixel units to the common reading line. As a result, it is sufficient to complete the reading of the count value held in the readout holding circuit during the exposure period in which the shift is performed in each stage, and thus, it is possible to secure the reading time.

Furthermore, in the first aspect, a reading line may be provided for each pixel unit of the M pixel units, a parallel-serial conversion unit configured to perform parallel-serial conversion of a count value of the counter held in the holding array unit may be provided for each pixel unit of the M pixel units, and the control unit may perform control to read a value parallel-serial converted by the parallel-serial conversion unit to a corresponding reading line. As a result, since only one reading line is required for each pixel unit, there is an effect that the number of reading lines can be reduced.

Furthermore, in the first aspect, for each pixel unit of the M pixel units, a blanking photon detection unit and a readout holding circuit that do not perform exposure may be included as the pixel circuit of the final stage, and the control unit may perform control to read the count value held in the readout holding circuit to the holding array unit. This brings about an effect of facilitating the layout of each pixel unit.

Furthermore, in the first aspect, the holding unit at the N stages in the holding unit may include a shift register, and may perform a shift operation at the same timing as the shift operation in the pixel unit. This brings about an effect that the count value of the counter read from the pixel array unit can be shifted and added.

Furthermore, in the first aspect, the holding unit may include an N-stage memories and a multiplexer that selects one of the N-stage memories, and the multiplexer may sequentially select the N-stage memories in synchronization with a shift of a reading row of the pixel unit. This brings about an effect that the count value of the counter read from the pixel array unit can be shifted and added.

Furthermore, in the first aspect, the control unit may read only a count value of a most significant bit of the pixel unit in the pixel array unit, shift a count value of bits other than the most significant bit to a pixel unit of a next stage, and obtain a total count value from the count value of the most significant bit counted by the holding unit and a value of a lower bit shifted to the pixel unit of the next stage in the holding array unit. This brings about an effect that the bit length read from the pixel array unit can be reduced and the number of circuits of the holding array unit can be reduced.

Furthermore, in the first aspect, the control unit may read only a count value of a most significant bit of the pixel unit in the pixel array unit, shift count values of all bits to the pixel unit of the next stage, detect overflow of the most significant bit in the holding array unit, and obtain a total count value from the number of times of overflow detection and a value of a lower bit shifted to the pixel unit of the next stage. This brings about an effect that the bit length read from the pixel array unit can be reduced and the number of circuits of the holding array unit can be reduced.

Furthermore, in the first aspect, the holding array unit may be arranged outside the semiconductor substrate on which the pixel array unit is formed. This brings about an effect that the chip size of the semiconductor substrate on which the pixel array unit is formed can be reduced.

Furthermore, in the first aspect, the holding array unit may be arranged in a semiconductor substrate on which the pixel array unit is formed, This brings about an effect of facilitating electrical connection of the holding array unit to the pixel array unit.

Furthermore, in the first aspect, a laminated chip structure in which at least two semiconductor substrates are laminated may be provided, the photon detection unit in the pixel array unit may be arranged on an upper semiconductor substrate, and the counter and the holding array unit in the pixel array unit may be arranged on a lower semiconductor substrate. This brings about an effect of facilitating electrical connection between each counter and the holding array unit.

Furthermore, in the first aspect, the light receiving unit of the photon detection unit may be an avalanche photodiode. This brings about an effect that photons can be detected.

### BRIEF DESCRIPTION OF DRAWINGS

FIG. 1 is a block diagram schematically illustrating an overall configuration of a photodetection apparatus according to a first embodiment of the present technology.

FIG. 2 is a diagram for explaining a photon detection unit in a pixel circuit of the photodetection apparatus according to the first embodiment of the present technology.

FIG. 3 is a diagram for explaining an example of operation of the photodetection apparatus according to the first embodiment of the present technology.

FIG. 4 is a plan view schematically illustrating an arrangement example 1 of the holding array unit of the photodetection apparatus according to the first embodiment of the present technology.

FIG. 5 is a plan view schematically illustrating an arrangement example 2 of the holding array unit of the photodetection apparatus according to the first embodiment of the present technology.

FIG. 6 is an exploded perspective view schematically illustrating an arrangement example 3 of the holding array unit of the photodetection apparatus according to the first embodiment of the present technology.

FIG. 7 is a diagram schematically illustrating a configuration of a pixel unit according to Example 1 of the photodetection apparatus according to a second embodiment of the present technology.

FIG. 8 is a diagram schematically illustrating a configuration of a pixel unit according to Example 2 of the photodetection apparatus according to the second embodiment of the present technology.

FIG. 9 is a diagram schematically illustrating a configuration of a pixel unit according to Example 3 of the photodetection apparatus according to the second embodiment of the present technology.

FIG. 10 is a view schematically illustrating a configuration of a main part of a photodetection apparatus according to a third embodiment of the present technology.

FIG. 11 is a timing chart for explaining the operation of the main part of the photodetection apparatus according to the third embodiment of the present technology.

FIG. 12 is a view schematically illustrating a configuration of a main part of a photodetection apparatus according to a fourth embodiment of the present technology.

FIG. 13 is a timing chart for explaining the operation of the main part of the photodetection apparatus according to the fourth embodiment of the present technology.

FIG. 14 is a circuit diagram illustrating a circuit configuration example 1 of a holding array unit according to a fifth embodiment of the present technology.

FIG. 15 is a circuit diagram illustrating a circuit configuration example 2 of the holding array unit according to the fifth embodiment of the present technology.

FIG. 16 is a circuit diagram illustrating a circuit configuration example of a pixel array unit and a holding array unit according to a sixth embodiment of the present technology.

FIG. 17 is a diagram illustrating a relationship of a count value CNT with respect to a pixel row rou according to the sixth embodiment of the present technology.

FIG. 18 is a circuit diagram illustrating a circuit configuration example of a pixel array unit and a holding array unit according to a seventh embodiment of the present technology.

FIG. 19 is a diagram illustrating a relationship of a count value CNT with respect to a pixel row rou according to the seventh embodiment of the present technology.

FIG. 20 is a diagram illustrating a schematic configuration example of a biological sample analysis apparatus according to an application example of the present technology.

### MODE FOR CARRYING OUT THE INVENTION

Modes for carrying out the present technology (hereinafter, referred to as embodiments) will be described below. The description will be given in the following order.
1. First Embodiment (Example of Providing Holding Array Unit Outside Pixel Array Unit and Performing TDI Processing)
2. Second Embodiment (Example of Specific Configuration of Pixel Unit for Performing TDI Processing)
3. Third Embodiment (Example in Which Readout Holding Circuits Are Provided for Each Pixel Circuit, and Held Values of Holding Circuits Are Read to Reading Line Common to Each Pixel Unit)
4. Fourth Embodiment (Example in Which Readout Holding Circuits Are Provided for Each Pixel Circuit, Held Values of Holding Circuits Are Parallel-Serial Converted, and Read to Reading Line)
5. Fifth Embodiment (Example of Another Circuit Configuration of Holding Array Unit)
6. Sixth Embodiment (Example in Which Count Value of Most Significant Bit of One Pixel Unit Is Read to Outside and Count Value of Remaining Bits Is Sent to Counter of Next Stage)
7. Seventh Embodiment (Example in Which Count Value of. Most Significant Bit of One Pixel Unit Is Read to Outside and Count Values of All Bits Are Sent to Counter of Next Stage)
8. Modifications
9. Application Example (Example of Application to Biological Sample Analysis Apparatus)
10. Configuration That Can Be Adopted by Present Technology

### 1. First Embodiment

### [Configuration Example of Photodetection Apparatus]

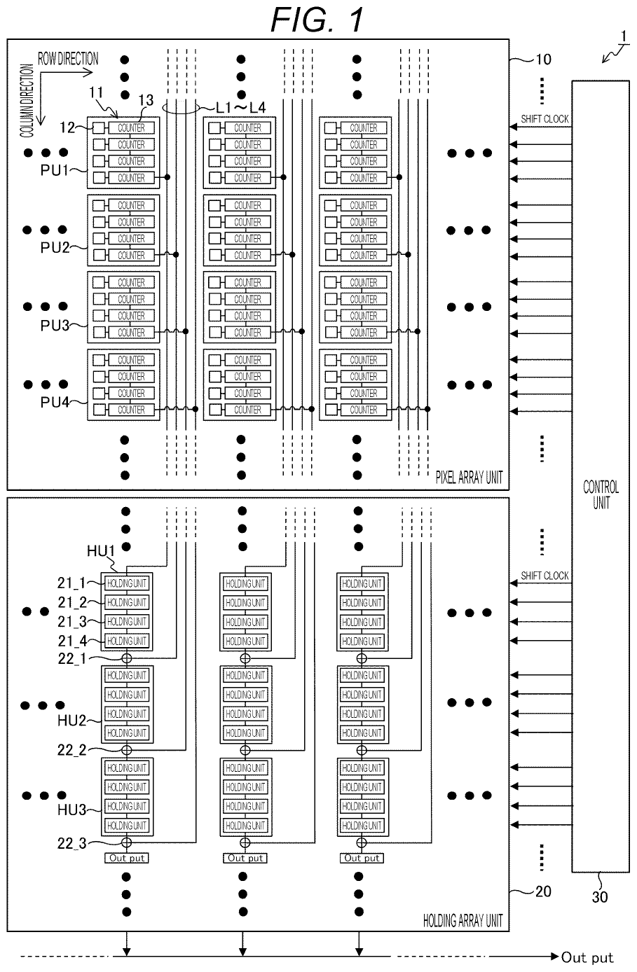

FIG. 1 is a block diagram schematically illustrating an overall configuration of a photodetection apparatus according to a first embodiment of the present technology. The photodetection apparatus 1 according to the first embodiment of the present technology includes a pixel array unit 10, a holding array unit 20, and a control unit 30.

The pixel array unit 10 includes a plurality of pixel circuits 11 that perform photoelectric conversion. The plurality of pixel circuits 11 is arranged in a matrix (array) in the effective pixel area of the pixel array unit 10. In the present specification, for convenience, an array unit in which a plurality of pixel circuits 11 is arranged in an array is referred to as a pixel array unit. In the photodetection apparatus 1 including the pixel array unit 10, for example, it is assumed that the imaging target object (subject) moves at a constant speed in the pixel column direction with respect to the pixel array unit 10.

The photodetection apparatus 1 according to the first embodiment of the present technology is a TDI sensor capable of acquiring high-sensitivity and low-noise image data by performing TDI processing of integrating a charge amount while shifting time in accordance with a moving speed of an imaging target object under the control of the control unit 30 for the pixel array unit 10 and the holding array unit 20.

Each of the plurality of pixel circuits 11 includes a photon detection unit 12 that generates a pulse signal in response to incidence of photons, and a counter 13 that counts the pulse signal generated by the photon detection unit 12. Details of the photon detection unit 12 in the pixel circuit 11 will be described later.

The counter 13 counts photons incident on the photon detection unit 12 in a certain period. The count value of the counter 13 is also a pixel value of the pixel circuit 11. The count value of the counter 13 is sent (shifted) to the next-stage counter 13 as an initial value. The next-stage counter 13 counts the pulse signal by adding to the initial value shifted from the previous stage counter 13. A series of processing of shifting and counting by the counter 13 in the pixel circuit 11 is also the above-described TDI processing,

### (Pixel Array Unit)

In the pixel array unit 10 of the photodetection apparatus 1 according to the first embodiment of the present technology, the pixel circuit 11 constitutes a pixel unit having one unit (one unit) of N stages (N is an integer) for each pixel column. The N stages are also N rows (N lines). Here, assuming that N=4, a pixel unit is configured with four rows (four lines) as one unit for each pixel column. Furthermore, M units (M is an integer) of the N-stage pixel units are arranged to configure the (N×M)-stage pixel array unit 10. Here, the pixel units PU1 to PU4 of four stages (four units) are configured with M=4.

In the four-stage (four) pixel units PU1 to PU4, each counter 13 of the plurality of pixel circuits 11 has a data shift function of writing the count value of the counter 13 belonging to the previous pixel row (line) of the same pixel column. Then, under the control of the control unit 30, each counter 13 of the plurality of pixel circuits 11 performs TDI processing (TDI operation) as follows.

After the counter 13 in the first stage performs the counting operation of the pulse signal generated by the photon detection unit 12, the counter 13 in the second stage writes the count value of the counter 13 in the first stage as an initial value, and adds the pulse signal generated by the photon detection unit 12 to the initial value to obtain the count value of the counter 13 in the second stage. The counter 13 in the third stage writes the count value of the counter 13 in the second stage as an initial value, and adds the pulse signal generated by the photon detection unit 12 to the initial value to obtain the count value of the counter 13 in the third stage. The counter 13 in the fourth stage writes the count value of the counter 13 in the third stage as an initial value, and adds the pulse signal generated by the photon detection unit 12 to the initial value to obtain the count value of the counter 13 in the fourth stage.

The count value of the counter 13 in each final stage (in this example, the fourth stage) of the four-stage pixel units PU1 to PU4 is read out through the reading lines L1 to L4 to the holding array unit 20 arranged outside the pixel array unit 10 for each pixel unit in units of the four-stage pixel units PU1 to PU4 under the control of the control unit 30.

### (Holding Array Unit)

The holding array unit 20 is provided outside the pixel array unit 10 and includes a plurality of holding units (holding circuits) arranged in a matrix (array).

In the present specification, for convenience, an array unit in which a plurality of holding units (holding circuits) is arranged in an array is referred to as a holding array unit.

Under the control of the control unit 30, the holding array unit 20 holds the count value of the counter 13 read through the reading lines L1 to L4 for each pixel unit of the pixel units PU1 to PU4 in four stages from the pixel array unit 10. The holding array unit 20 includes (M-1)-stage holding units and addition circuits, in this example, 3-stage holding units HU1 to HU3 and 3-stage addition circuits 22_1 to 22_3.

Each of the three-stage holding units HU1 to HU3 includes an N-stage, in this example, four-stage holding unit 21_1 to 21_4 that holds the count value of the counter 13 read from one pixel unit of the four-stage pixel units PU1 to PU4 in the pixel array unit 10. The holding unit 21_1 to 21_4 has a function of shifting the held value under the control of the control unit 30.

The three-stage addition circuit 22_1 to 22_3 performs processing of adding the held value of the holding unit 21_4 in the final stage in the holding unit 21_1 to 21_4 in the four stages and the count value of the counter 13 read from the pixel unit in the next stage of one of the pixel units PU1 to PU4 in the four stages in the pixel array unit 10.

In the holding array unit 20, the holding unit HU1 of the first unit uses the count value of the counter 13 output from the pixel unit PU1 of the first stage of the pixel array unit 10 as an input. Then, the output of the holding unit HU1 of the first unit and the output of the pixel unit PU2 of the second stage of the pixel array unit 10 are added by the addition circuit 22_1 of the first stage, and the addition result becomes an input of the holding unit. HU2 of the second unit.

The output of the holding unit HU2 of the second unit and the output of the pixel unit PU3 of the third unit of the pixel array unit 10 are added by the addition circuit 22_2 of the second stage, and the addition result becomes an input of the holding unit HU3 of the third unit. The output of the holding unit HU3 of the third unit and the output of the pixel unit PU4 of the fourth stage of the pixel array unit 10 are added by the addition circuit 22_3 of the third stage, and the addition result is obtained as a total count value.

Under the control of the control unit 30, the shift operation of the pixel units PU1 to PU4 in the pixel array unit 10 and the shift operation of the holding units HU1 to HU3 in the holding array unit 20 are performed at the same timing.

### (Control Unit)

The control unit 30 appropriately gives a control signal including a shift clock to each pixel unit of the four-stage pixel units PU1 to PU4 in the pixel array unit 10 and the three-stage holding units HU1 to HU3 in the holding array unit 20. Then, the control unit 30 performs a shift operation of writing the count value of the counter of the previous stage to the counter of the next stage before the exposure of the next line is started in the pixel unit, and performs control to read the count value of the counter 13 for each pixel unit of the pixel units PU1 to PU4 of the four stages from the pixel array unit 10 to the holding array unit 20.

### (Photon Detection Unit)

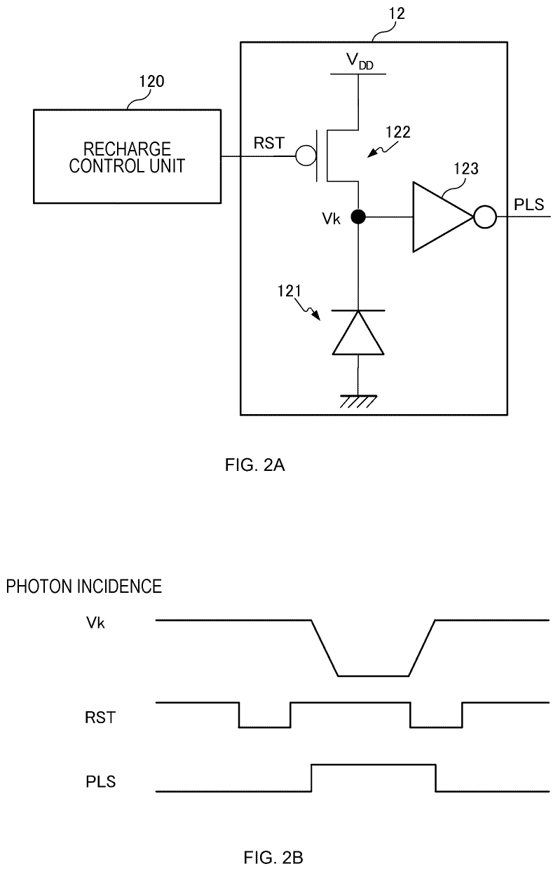

FIG. 2 is a diagram for explaining the photon detection unit 12 in the pixel circuit 11. a of FIG. 2 is a circuit diagram illustrating an example of a circuit configuration of the photon detection unit 12. The photon detection unit 12 includes, for example, a light receiving unit 121, a quenching unit 122, and a waveform shaping unit 123. The reset pulse RST is given to the photon detection unit 12 from the recharge control unit 120 which is an external circuit.

An avalanche photodiode (APD) can be used as the light receiving unit 121. In a Geiger mode avalanche photodiode, when a voltage equal to or higher than a breakdown voltage is applied between terminals, an avalanche phenomenon occurs due to incidence of a single photon. An avalanche photodiode that multiplies a single photon by an avalanche phenomenon is called a single photon avalanche diode (SPAD). Here, for example, a case where a SPAD element is used as the light receiving unit 121 is illustrated. For the photon detection unit 12, for example, a resistance element may be used instead of the quenching unit 122.

The quenching unit 122 has a function (quenching function) of stopping the avalanche phenomenon by lowering the voltage applied to the light receiving unit 121 to the breakdown voltage. The quenching unit 122 further has a function of causing the light receiving unit 121 to detect photons again by setting the voltage applied to the light receiving unit 121 to a bias voltage equal to or higher than the breakdown voltage. The quenching unit 122 includes, for example, a P-type metal oxide semiconductor (MOS) transistor, is connected between a node of the power supply voltage Von and the light receiving unit 121 (specifically, the cathode electrode of the SPAD element), and performs recharge on the light receiving unit 121.

A reset pulse RST is given from the recharge control unit 120, which is an external circuit, to the gate electrode of the P-type MOS transistor constituting the quenching unit 122. The reset pulse RST is a recharge pulse for controlling recharge timing of the light receiving unit 121.

The waveform shaping unit 123 includes, for example, a CMOS inverter, performs waveform shaping of the output of the light receiving unit 121, that is, the cathode voltage Vk of the P-type MOS transistor, and outputs a pulse signal PLS.

As described above, the photon detection unit 12 is configured to periodically reset the light receiving unit 121 by the reset pulse RST provided from the recharge control unit 120 which is an external circuit. As a result, the counter 13 can be controlled to the maximum count number corresponding to the bit length.

b of FIG. 2 is a timing chart illustrating a timing relationship among the cathode voltage Vk, the reset pulse RST, and the pulse signal PLS of the P-type MOS transistor.

### [Operation Example of Photodetection Apparatus]

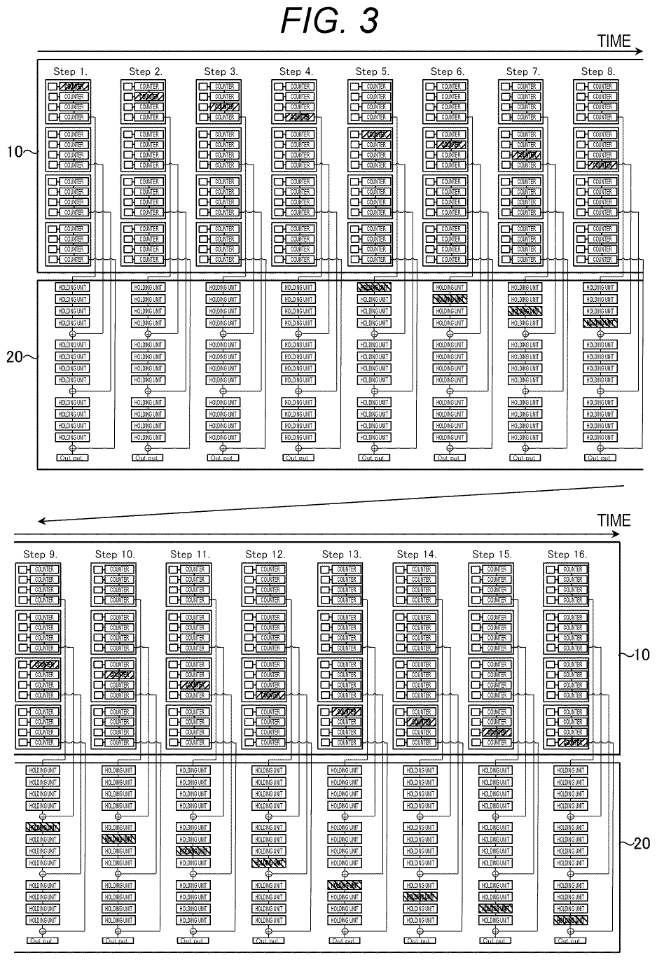

Next, an example of the operation of the photodetection apparatus 1 in the above-described first embodiment will be described with reference to FIG. 3. FIG. 3 is a diagram for explaining an example of the operation of the photodetection apparatus 1 in the first embodiment. FIG. 3 exemplifies a case of operation of the pixel units PU1 to PU4 in four stages (four units) , the holding units HU1 to HU3 in three stages, and the addition circuit 22_1 to 22_3 in three stages in one pixel column.

When the shift operation in the pixel array unit 10 reaches the Nth stage (in this example, the fourth stage) of the pixel unit PU1 of the first unit (Step1 to 4), the count value of the counter 13 in the fourth stage of the pixel unit PU1 of the first unit is shifted to the holding unit 21_1 in the first stage of the holding unit HU1 of the first unit in the holding array unit 20 at the next shift timing (Step5). At the same time, the counting operation is newly started in the first stage of the pixel unit PU2 of the second unit.

Next, at the same time as the shifting operation of the pixel unit PU2 of the second unit in the pixel array unit 10, the shifting operation is also performed in the holding unit HU1 of the first unit in the holding array unit 20 (Step6 to 8). Then, when the shift operation reaches the fourth stage, the count value of the fourth stage of the pixel unit PU2 of the second unit in the pixel array unit 10 and the held value of the fourth stage of the holding unit HU1 of the first unit in the holding array unit 20 are added at the timing of the next shift, and the addition value is held in the next holding unit, that is, the first stage of the holding unit HU2 of the second unit (Step9). At the same time, the counting operation is newly started in the first stage of the pixel unit PU3 of the third unit in the pixel array unit 10.

Next, at the same time as the shifting operation of the pixel unit PU3 of the third unit in the pixel array unit 10, the shifting operation is also performed in the holding unit HU2 of the second unit in the holding array unit 20 (Step10 to 12). Then, when the shift operation reaches the fourth stage, the count value of the fourth stage of the pixel unit PU3 of the third unit in the pixel array unit 10 and the held value of the fourth stage of the holding unit HU2 of the second unit in the holding array unit 20 are added at the timing of the next shift, and the addition value is held in the next holding unit, that is, the first stage of the holding unit HU3 of the third unit (Step13). At the same time, the counting operation is newly started in the first stage of the pixel unit PU4 of the fourth unit in the pixel array unit 10.

Next, at the same time as the shifting operation of the pixel unit PU4 of the fourth unit in the pixel array unit 10, the shifting operation is also performed in the holding unit HU3 of the third unit in the holding array unit 20 (Step14 to 16). Then, when the shift operation reaches the fourth stage, the count value of the fourth stage of the pixel unit PU4 of the fourth unit in the pixel array unit 10 and the held value of the fourth stage of the holding unit HU3 of the third unit in the holding array unit 20 are added at the next shift timing, and the addition value is output as a total count value.

The series of processing described above, that is, the processing of reading the count value of the counter 13 to the holding array unit 20 outside the pixel array unit 10 for each N stages and repeating the processing of shifting and adding in the holding array unit 20 outside is the TDI processing executed in the photodetection apparatus 1 according to the first embodiment of the present technology.

As described above, in the photodetection apparatus 1 according to the first embodiment of the present technology, the holding array unit 20 is provided outside the pixel array unit 10, and the count value of the counter 13 is read out to the holding array unit 20 for each N stages and shifted and added, so that the circuit area in the pixel array unit 10 can be reduced. Then, since the circuit area can be reduced, the TDI processing can be made multistage, and accordingly, the total count value (total count number) can be increased, so that the dynamic range can be expanded.

### [Arrangement Example of Holding Array Unit]

Next, an arrangement example of the holding array unit 20 of the photodetection apparatus 1 according to the first embodiment of the present technology will be described. The arrangement example of the holding array unit 20 is similar in each embodiment described later.

Hereinafter, the arrangement example 1, the arrangement example 2, and the arrangement example 3 will be described, but which arrangement example is adopted is arbitrary.

### Arrangement Example 1

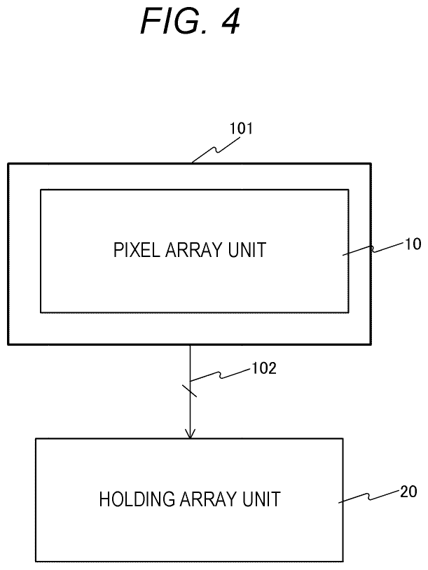

FIG. 4 is a plan view schematically illustrating the arrangement example 1 of the holding array unit 20 of the photodetection apparatus 1 according to the first embodiment of the present technology. In the arrangement example 1, the pixel array unit 10 in which the plurality of pixel circuits 11 is arranged in an array is formed on the semiconductor substrate 101. The semiconductor substrate 101 on which the pixel array unit 10 is formed is a sensor chip. Then, in the arrangement example 1, the pixel array unit 10 is formed in the semiconductor substrate 101, whereas the holding array unit 20 is arranged outside the semiconductor substrate 101. The pixel array unit 10 arranged in the semiconductor substrate 101 and the holding array unit 20 arranged outside the semiconductor substrate 101 are electrically connected through a multi-bit reading line 102. By disposing the holding array unit 20 outside the semiconductor substrate 101 on which the pixel array unit 10 is formed, the chip size of the semiconductor substrate 101 can be reduced.

### Arrangement Example 2

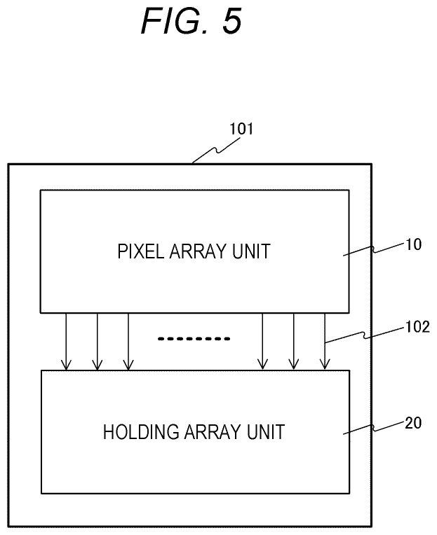

FIG. 5 is a plan view schematically illustrating the arrangement example 2 of the holding array unit 20 of the photodetection apparatus 1 according to the first embodiment of the present technology. In the arrangement example 2, the pixel array unit 10 in which the plurality of pixel circuits 11 is arranged in an array is formed on the semiconductor substrate 101, and the holding array unit 20 is formed on the same semiconductor substrate 101. On the semiconductor substrate 101, the pixel array unit 10 and the holding array unit 20 are electrically connected through the reading line 102. As described above, by arranging the holding array unit 20 on the same semiconductor substrate 101 as the pixel array unit 10, it is easy to electrically connect the holding array unit 20 to the pixel array unit 10.

### Arrangement Example 3

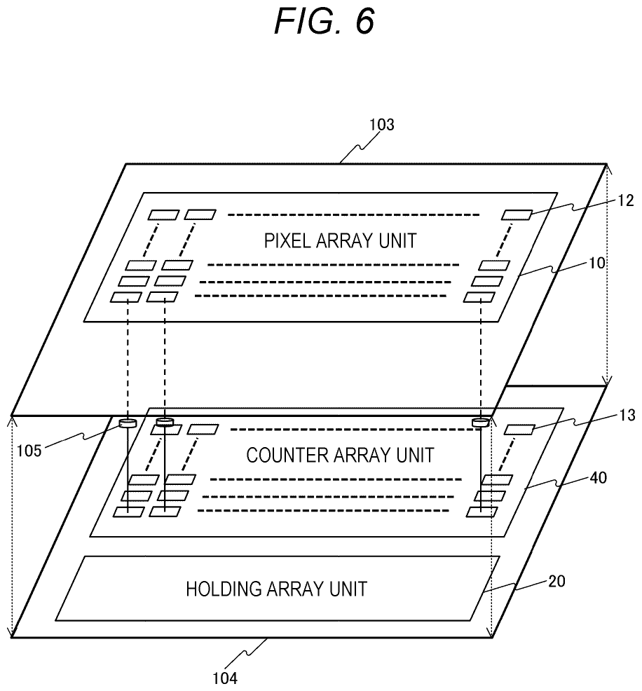

FIG. 6 is an exploded perspective view schematically illustrating the arrangement example 3 of the holding array unit 20 of the photodetection apparatus 1 according to the first embodiment of the present technology, The arrangement example 3 is an arrangement example in a laminated chip structure in which at least two semiconductor substrates are laminated.

The arrangement example 3 has, for example, a two-layer laminated chip structure in which a first semiconductor substrate 103 and a second semiconductor substrate 104 are laminated. In this two-layer laminated chip structure, the pixel array unit 10 excluding each counter 13 of the plurality of pixel circuits 11 is formed on the upper first semiconductor substrate 103, and a counter array unit 40 in which each counter 13 of the plurality of pixel circuits 11 is arranged in an array and the holding array unit 20 are formed on the lower second semiconductor substrate 104.

In this two-layer laminated chip structure, the upper first semiconductor substrate 103 on which the pixel array unit 10 is formed is a sensor chip, whereas the lower second semiconductor substrate 104 on which the counter array unit 40 and the holding array unit 20 are formed is a logic chip. Then, each photon detection unit 12 of the pixel array unit 10 on the upper sensor chip and each counter 13 of the counter array unit 40 on the lower logic chip are electrically connected via a connection unit 105 such as a Cu-Cu connection (junction), a through silicon via (TSV), or a microbump.

As described above, the photon detection unit 12 in the pixel array unit 10 is arranged on the first semiconductor substrate 103 on the upper layer, and the counter array unit 40 and the holding array unit 20 in the pixel array unit 10 are arranged on the second semiconductor substrate 104 on the lower layer, thereby facilitating electrical connection between each counter 13 of the counter array unit 40 and the holding array unit 20.

Note that, in the arrangement example 3, the pixel array unit 10 excluding each counter 13 of the plurality of pixel circuits 11 is formed on the first semiconductor substrate 103 of the first layer; however, as in the case of the arrangement example 1, the pixel array unit 10 including each counter 13 of the plurality of pixel circuits 11 may be formed.

### 2. Second Embodiment

A second embodiment of the present technology is an example of a specific configuration of a pixel unit that performs TDI processing. Note that the overall configuration of the photodetection apparatus 1 is similar to that of the first embodiment described above, and thus detailed description will be omitted. This point is similar in each embodiment described later.

### Example 1

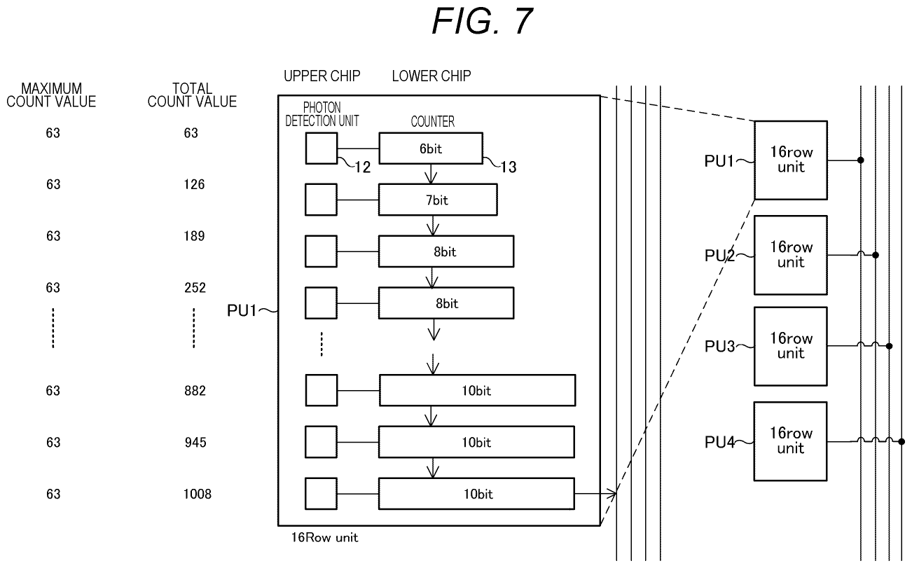

Example 1 is an example in which the bit length of the counter 13 of each stage in each pixel unit is set on the basis of the maximum value of the count value (count number) of the counter 13 of the first stage and the number of stages in one unit. FIG. 7 is a diagram schematically illustrating a configuration of a pixel unit according to Example 1 of the photodetection apparatus according to the second embodiment of the present technology.

FIG. 7 illustrates, for example, a configuration in which, in the pixel units PU1 to PU4 having a four-stage configuration, the photon detection unit 12 and the counter 13 of, for example, 16 stages (N=16) are set as one unit for the pixel unit PU1 of the first stage. Furthermore, here, for example, in the two-layer laminated chip structure illustrated in FIG. 6, a configuration in which the photon detection unit 12 is formed on the first semiconductor substrate 103 (upper chip) of the first layer and the counter 13 is formed on the second semiconductor substrate 104 (lower chip) of the second layer is illustrated. It similarly applies to Examples 2 and 3 described later.

The pixel unit PU1 according to Example 1 has a configuration in which, when the maximum value COUNTmax of the count value of the first-stage counter 13 is set and the number of stages in one unit is N (in this example, N=16), the bit length of the counter 13 in each stage in one unit is set to the bit length corresponding to the count value of (COUNTmax×N).

Specifically, assuming that the count value per period is 63 at the maximum, when a 6-bit counter is arranged as the first-stage counter, a 7-bit counter, which is the bit length corresponding to the maximum count value 126 (=63×2), is arranged in the second stage, and an 8-bit counter, which is the bit length corresponding to the maximum count value 189 (=63×3), is arranged in the third stage. Hereinafter, similarly, the bit length of the counter 13 of each stage is set, and in the final stage (in this example, the 16th step), a 10 bit counter having the bit length corresponding to the maximum count value 1008 (=63×16) is arranged.

Here, the setting of the bit length of the counter 13 of each stage has been described by taking the pixel unit PU1 of the first stage as an example, but the pixel units PU2 to PU4 of the second to fourth stages are also similar to the pixel unit PU1 of the first stage.

As described above, in the pixel unit according to Example 1, since the bit length of the counter 13 in each stage in one unit is set to the maximum value of the count value of the counter 13 in the first stage x the number of stages N in one unit, one unit can be formed with a smaller area.

### Example 2

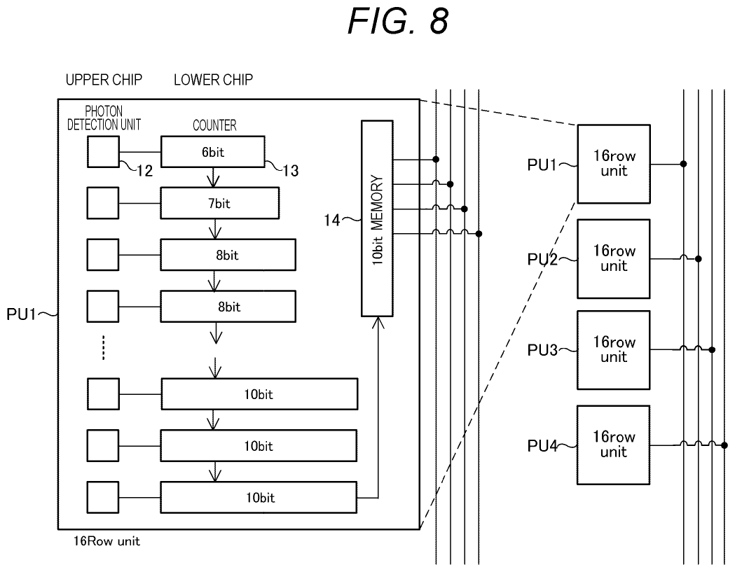

Example 2 is an example in which at least one readout holding circuit is provided in each pixel unit, FIG. 8 is a diagram schematically illustrating a configuration of a pixel unit according to Example 2 of the photodetection apparatus according to the second embodiment of the present technology.

The pixel unit PU1 according to Example 2 includes, for example, at least one memory 14 as a readout holding circuit in the pixel unit. The bit width of the memory 14 is the same as the bit width of the counter 13 in the Nth stage (in this example, N=16) of the pixel unit PU1, that is, 10 bits. Then, the count value of the Nth stage counter 13 is held in the memory 14. The count value held in the memory 14 is read to the holding array unit 20 under the control of the control unit 30.

Here, it has been described that at least one readout holding circuit is provided in the pixel unit by taking the pixel unit PU1 of the first stage as an example, but the pixel units PU2 to PU4 of the second to fourth stages are also similar to the pixel unit PU1 of the first stage.

As described above, the pixel unit according to Example 2 is configured to include at least one memory 14 as a readout holding circuit in each pixel unit. As a result, it is sufficient to complete the reading of the count value held in the memory 14 during the exposure period in which the shift operation is performed in each stage, and thus, the reading time can be secured. As a result, it is possible to cope with a case where the number of pixel units increases,

### Example 3

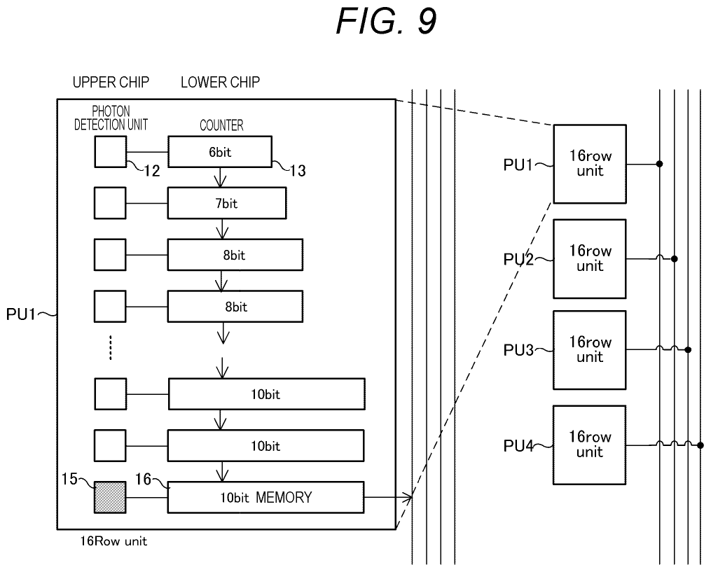

Example 3 is an example in which each pixel unit includes a photon detection unit for blanking that does not perform exposure and a readout holding circuit corresponding thereto. FIG. 9 is a diagram schematically illustrating a configuration of a pixel unit according to Example 3 of the photodetection apparatus according to the second embodiment of the present technology.

The pixel unit PU1 according to Example 3 includes a blanking photon detection unit that does not perform exposure and a memory 16 as a readout holding circuit Corresponding to the blanking photon detection unit 15 as a pixel circuit of a final stage (Nth stage). In the pixel circuit of the final stage, the count value held in the memory 16 is read out to the holding array unit 20 during the exposure period under the control of the control unit 30 without performing exposure.

Here, the first stage pixel unit PU1 is taken as an example, and the blanking photon detection unit 15 that does not perform exposure and the corresponding readout holding circuit are provided as the final stage pixel circuit. However, the second to fourth stage pixel units PU2 to PU4 are similar to the first stage pixel unit PU1.

As described above, in the pixel unit according to Example 3, since the blanking photon detection unit 15 and the readout holding circuit are provided as the pixel circuit of the final stage in each pixel unit, the layout of each pixel unit becomes easier as compared with Example 2. Furthermore, it is sufficient to complete the reading of the count value held in the readout holding circuit during the exposure period in which the shift is performed in each stage, and thus, it is possible to secure the reading time.

### 3. Third Embodiment

A third embodiment of the present technology is an example in which a readout holding circuit is provided for each pixel circuit of a pixel unit, and a count value (held value) held in the holding circuit is read out to a reading line common to each pixel unit by a switch element.

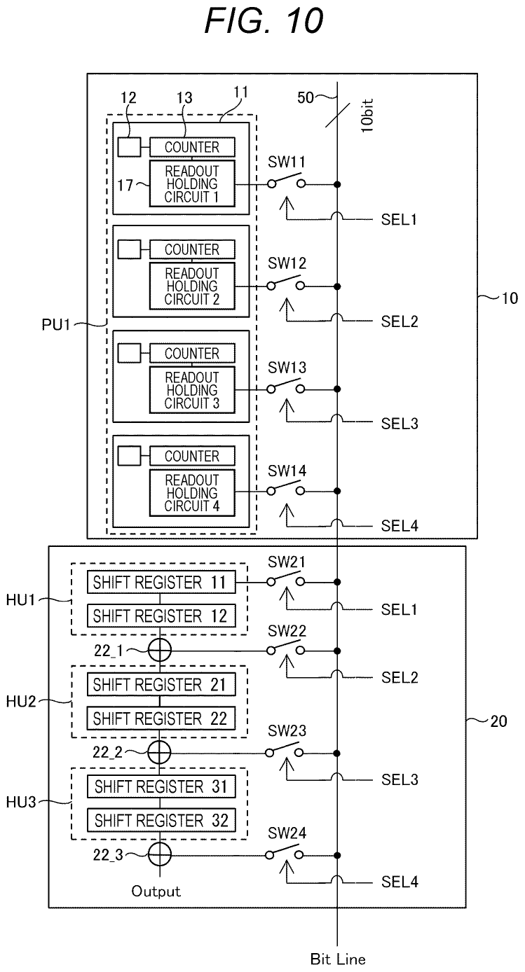

FIG. 10 is a diagram schematically illustrating a configuration of a main part of the photodetection apparatus according to the third embodiment of the present technology. In FIG. 10, for the main part of the photodetection apparatus 1, specifically, for one pixel column, the circuit configuration of the pixel unit PU1 among the pixel units PU1 to PU4 of four stages (four units) in the pixel array unit 10 and the holding units HU1 to HU3 of three stages in the holding array unit 20 is illustrated.

In the pixel unit PU1, the pixel circuit 11 includes a readout holding circuit 17 in addition to the photon detection unit 12 and the counter 13.

Furthermore, the pixel unit PU1 includes switch elements SW11 to SW14 for each pixel circuit 11.

In the pixel array unit 10 and the holding array unit 20, a reading line 50 corresponding to the bit length (for example, 10 bits) of the counter 13 is wired for each pixel column. Then, the readout holding circuit 17 and the reading line 50 in each pixel circuit 11 are selectively connected by the switch elements SW11 to SW14 under the control of the selection signals SEL1 to SEL4 provided from the control unit 30.

In the holding array unit 20, the holding unit HU1 of the first stage includes a shift register 11 and a shift register 12 of two stages. The holding unit HU2 of the second stage includes a shift register 21 and a shift register 22 of two stages. The holding unit HU3 of the third stage includes a shift register 31 and a shift register 32 of two stages.

A switch element SW21 is provided between the input terminal of the shift register 11 of the holding unit HU1 of the first stage and the reading line 50. When the switch element SW21 is turned on (closed) in response to the selection signal SEL1 supplied from the control unit 30, the count value of the first-stage counter 13 of the pixel unit PU1 supplied through the reading line 50 is input to the shift register 11.

A switch element SW22 is provided between the addition circuit 22_1 of the first stage and the reading line 50. When the switch element SW22 is turned on in response to the selection signal SEL2 supplied from the control unit 30, the count value of the counter 13 in the second stage of the pixel unit PU1 supplied through the reading line 50 is input to the addition circuit 22_1. As a result, the addition circuit 22_1 adds the held value of the holding unit HU1 in the first stage and the count value of the counter 13 in the second stage of the pixel unit PU1, and uses the addition result as an input to the holding unit HU2 in the second stage.

A switch element SW23 is provided between the second-stage addition circuit 22_2 and the reading line 50. When the switch element SW23 is turned on in response to the selection signal SEL3 supplied from the control unit 30, the count value of the counter 13 in the third stage of the pixel unit PU1 supplied through the reading line 50 is input to the addition circuit 22_2. As a result, the addition circuit 22_2 adds the held value of the holding unit HU2 in the second stage and the count value of the counter 13 in the third stage of the pixel unit PU1, and uses the addition result as an input to the holding unit HU3 in the third stage.

A switch element SW24 is provided between the addition circuit 22_3 of the third stage and the reading line 50. The switch element SW24 is supplied from the control unit 30 and is turned on in response to the selection signal SEL4, thereby inputting the count value of the counter 13 in the fourth stage of the pixel unit PU1 supplied through the reading line 50 to the addition £ circuit 22_3. As a result, the addition circuit 22_3 adds the held value of the holding unit HU3 of the third stage and the count value of the counter 13 of the fourth stage of the pixel unit PU1, and outputs the addition result as a total count value.

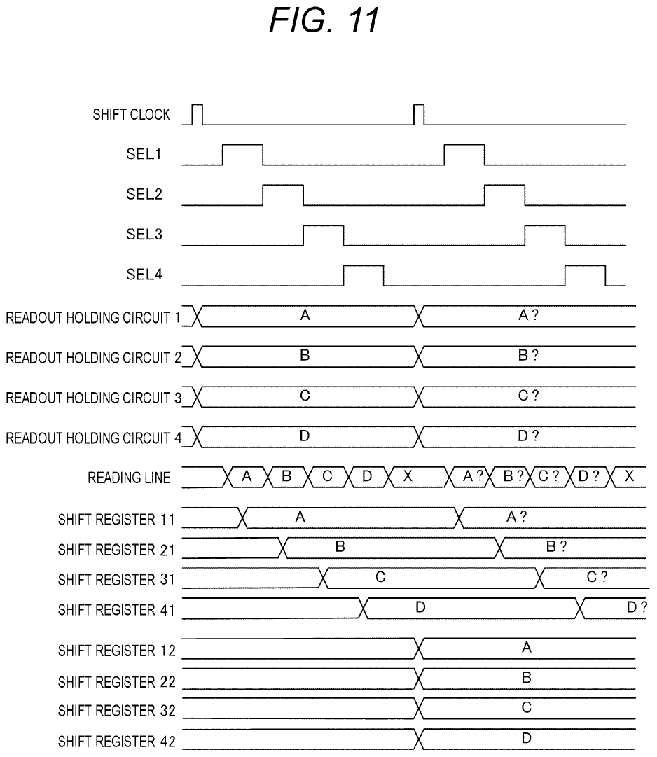

FIG. 11 is a timing chart for explaining the operation of the main part of the photodetection apparatus according to the third embodiment of the present technology. FIG. 11 illustrates a timing relationship between the shift clocks and the selection signals SEL1 to SEL4 provided from the control unit 30 to the pixel unit PU1 and the holding units HU1 to HU3, and states of the shift registers of the readout holding circuit 1 to 4 and the holding units HU1 to HU3 of the pixel unit PU1.

As described above, in the photodetection apparatus 1 according to the third embodiment of the present technology, each pixel unit is sequentially connected to the reading line 50 by the switch elements SW11 to SW14 during the exposure period, that is, during the period in which the readout holding circuit 1 to 4 of the pixel unit PU1 holds the count value, At the same time, the input terminals of the holding units HU1 to HU3 Corresponding to the readout holding circuits connected to the reading line 50 are connected to the reading line 50 by the switch elements SW21 to SW24, so that the held values (count values) are sequentially read from the readout holding circuit 1 to 4 of the pixel array unit 10 to the holding array unit 20.

As described above, the readout holding circuit 17 is provided for each pixel circuit 11 of the pixel unit, and the held value (count value) of the readout holding circuit 17 is read out to the reading line 50 common to the pixel units, whereby the number of reading lines can be reduced.

### 4. Fourth Embodiment

A fourth embodiment of the present technology is an example in which a readout holding circuit is provided for each pixel circuit of a pixel unit, and a count value (held value) held in the holding circuit is parallel-serial converted and read out to a reading line.

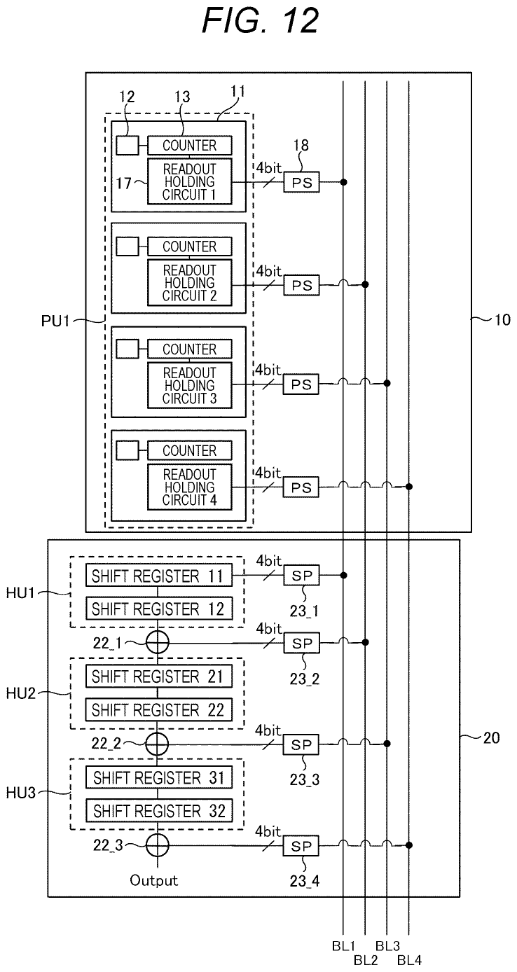

FIG. 12 is a diagram schematically illustrating a configuration of a main part of the photodetection apparatus according to the fourth embodiment of the present technology. FIG. 12 illustrates a circuit configuration of a main part of the photodetection apparatus 1, specifically, for one pixel column, the pixel unit PU1 among the four stages (four units) of pixel units PU1 to PU4 in the pixel array unit 10, and the three stages of holding units HU1 to HU3 in the holding array unit 20.

In the pixel unit PU1, the pixel circuit 11 includes a readout holding circuit 17 in addition to the photon detection unit 12 and the counter 13. The readout holding circuit 17 outputs the count value of the counter 13 held for counting as, for example, 4-bit parallel data.

The pixel unit PU1 includes a parallel-serial conversion circuit 18 as a subsequent stage circuit of the readout holding circuit 17 for each pixel circuit 11. In FIG. 12, the parallel-serial conversion circuit is abbreviated as “PS”.

In the pixel array unit 10 and the holding array unit 20, the number of reading lines BL1 to BL4 corresponding to the number of stages of the pixel unit PU1 is wired for each pixel column.

In the pixel unit PU1, the parallel-serial conversion circuit 18 corresponding to each pixel circuit 11 converts the parallel data output from the readout holding circuit 17 into serial data and outputs the serial data to the corresponding reading lines BL1 to BL4.

In the holding array unit 20, the holding unit HU1 of the first stage is configured by the shift register 1212 of two stages. The holding unit HU2 of the second stage includes shift registers 21 and 22 of two stages. The holding unit HU3 of the third stage includes shift registers 31 and 32 of two stages.

A serial-parallel conversion circuit 23_1 is disposed between the input terminal of the shift register 11 of the holding unit HU1 of the first stage and the reading line BL1. In FIG. 12, the serial-parallel conversion circuit is abbreviated as “SP”. The serial-parallel conversion circuit 23_1 converts serial data regarding the count value of the counter 13 in the first stage of the pixel unit PU1 supplied through the reading line BL1 into parallel data and inputs the parallel data to the shift register 11.

A serial-parallel conversion circuit 23_2 is disposed between the addition circuit 22_1 in the first stage and the reading line BL2. The serial-parallel conversion circuit 23_2 converts serial data regarding the count value of the counter 13 in the second stage of the pixel unit PU1 supplied through the reading line BL2 into parallel data and inputs the parallel data to the addition circuit 22_1. As a result, the addition circuit 22_1 adds the held value of the holding unit HU1 in the first stage and the count value of the counter 13 in the second stage of the pixel unit PU1, and uses the addition result as an input to the holding unit HU2 in the second stage.

A serial-parallel conversion circuit 23_3 is disposed between the second-stage addition circuit 22_2 and the reading line BL3. The serial-parallel conversion circuit 23_3 converts serial data regarding the count value of the counter 13 in the third stage of the pixel unit PU1 supplied through the reading line BL3 into parallel data and inputs the parallel data to the addition circuit 22_2. As a result, the addition circuit 22_2 adds the held value of the holding unit HU2 in the second stage and the count value of the counter 13 in the third stage of the pixel unit PU1, and uses the addition result as an input to the holding unit HU3 in the third stage.

A serial-parallel conversion circuit 23_4 is disposed between the addition circuit 22_3 in the third stage and the reading line BL4. The serial-parallel conversion circuit 23_4 converts serial data regarding the count value of the counter 13 in the fourth stage of the pixel unit PU1 supplied through the reading line BL4 into parallel data and inputs the parallel data to the addition circuit 22_3. As a result, the addition circuit 22_3 adds the held value of the holding unit HU3 of the third stage and the count value of the counter 13 of the fourth stage of the pixel unit PU1, and outputs the addition result as a total count value.

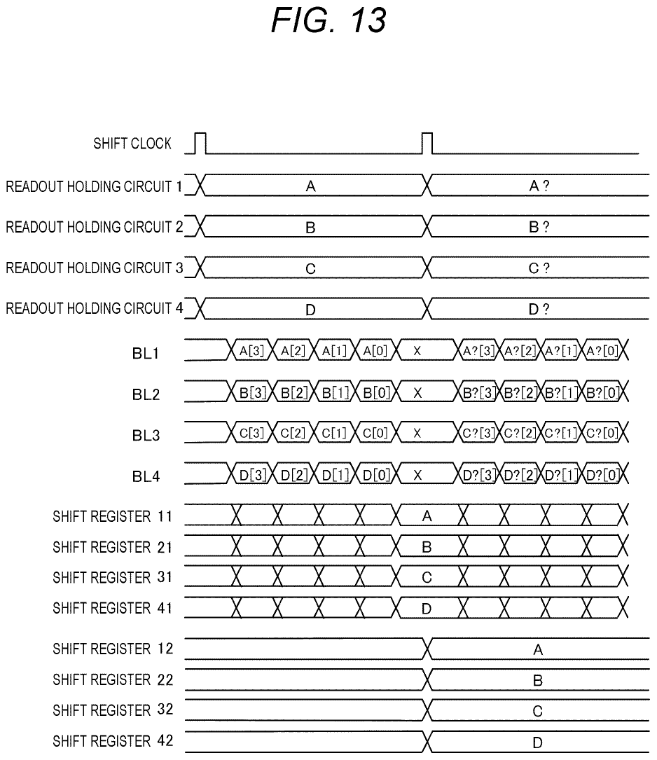

FIG. 13 is a timing chart for explaining the operation of the main part of the photodetection apparatus according to the fourth embodiment of the present technology. FIG. 13 illustrates the readout holding circuit 1 to 4 of the pixel unit PU1, the data of the reading lines BL1 to BL4, and the states of the shift registers of the holding units HU1 to HU3 with respect to the shift clocks provided from the control unit 30 to the pixel unit PU1 and the holding units HU1 to HU3.

As described above, in the photodetection apparatus 1 according to the fourth embodiment of the present technology, the count value (held value) held in the readout holding circuit provided for each pixel circuit of the pixel unit is parallel-serial converted and read out to the reading line, so that one reading line is sufficient for each pixel unit, and the number of reading lines can be reduced.

### 5. Fifth Embodiment

The fifth embodiment of the present technology is an example of another circuit configuration of the holding array unit 20. Hereinafter, two circuit configuration examples of the circuit configuration example 1 and the circuit configuration example 2 will be described as another example of the circuit configuration of the holding array unit 20.

### Circuit Configuration Example 1

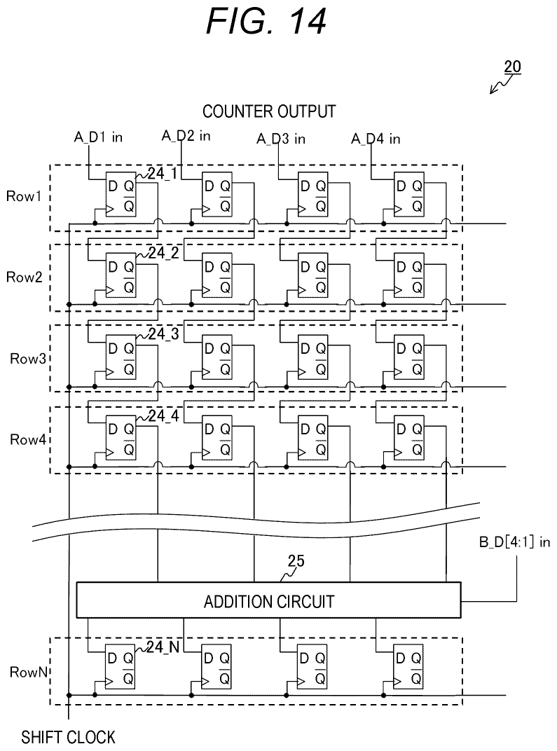

FIG. 14 is a circuit diagram illustrating a circuit configuration example 1 of the holding array unit 20 according to the fifth embodiment of the present technology. In FIG. 14, as an example, the holding units are N stages (Row1 to RowN), and the data (count value) input from the pixel array unit 10 is data of 4 bits (A_D1 to A_D4).

Hereinafter, the circuit configuration of the holding unit of the column to which the data A_D1 is input will be described, but the circuit configuration of the holding unit of the column to which the data A_D2 to A_D4 are input is also the same as the circuit configuration of the holding unit of the column to which the data A_D1 is input.

The holding unit of the column to which the data A_D1 is input includes an N-stage D-type flip-flop 24_1 to 24_N and an addition circuit 25. The D-type flip-flop 24_1 uses data A_D1 input from the pixel array unit 10 as a D input. The D-type flip-flop 24_1 to 24_N configures a shift register by using the Q output as a next-stage D input, and performs a shift operation at the same timing as the shift operation in the pixel array unit 10 in synchronization with a shift clock provided from the control unit 30 illustrated in FIG. 1.

The addition circuit 25 adds the Q output of the D-type flip-flop (not illustrated) of the N-1 stage and the data B_D supplied from the pixel array unit 10, and supplies the addition result to the D-type flip-flop 24_N of the final stage as the D input.

Also by the holding array unit 20 according to the circuit configuration example 1 of the circuit configuration described above, similarly to the case of the holding array unit 20 in the first embodiment, the count value of the counter 13 read from the pixel array unit 10 can be shifted and added.

### Second Circuit Configuration Example

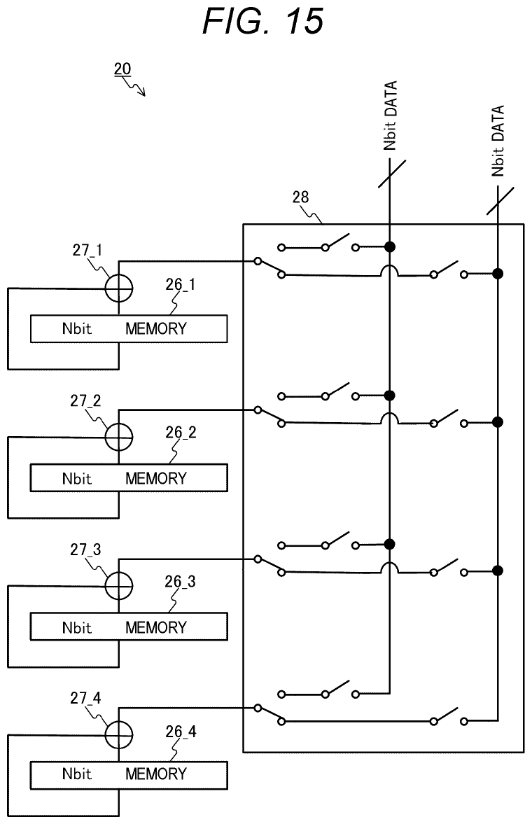

FIG. 15 is a circuit diagram illustrating a circuit configuration example 2 of the holding array unit 20 according to the fifth embodiment of the present technology. FIG. 15 illustrates one holding unit having an N-stage (in this example, four stages) configuration.

In the holding array unit 20 according to the circuit configuration example 2, the holding unit includes N-bit memories 26 to 1 to 26-4, addition circuits 27 to 1 to 27-4, and a multiplexer 28. In this holding unit, by sequentially selecting the memories 26-1 to 26-4 in synchronization with the shift of the reading row (line) of the pixel unit, the holding unit is held in another memory every time.

Specifically, when attention is paid to one memory 26-1, first, the output (count value) of the pixel unit of the first unit is held, then the output of the pixel unit of the second unit is fetched after the period of the N-stage shift operation, the pre-held value and the addition circuit 27-1 add up, and the addition value is held. As a result, it is possible to perform driving equivalent to the shift operation of the holding array unit 20 in the first embodiment.

Also by the holding array unit 20 according to the circuit configuration example 2 of the circuit configuration described above, similarly to the case of the holding array unit 20 in the first embodiment, the count value of the counter 13 read from the pixel array unit 10 can be shifted and added.

### 6. Sixth Embodiment

The sixth embodiment of the present technology is an example in which the count value of the most significant (MSB) bit of one pixel unit is read to the outside, and the count value of the remaining bits is sent to the next-stage counter.

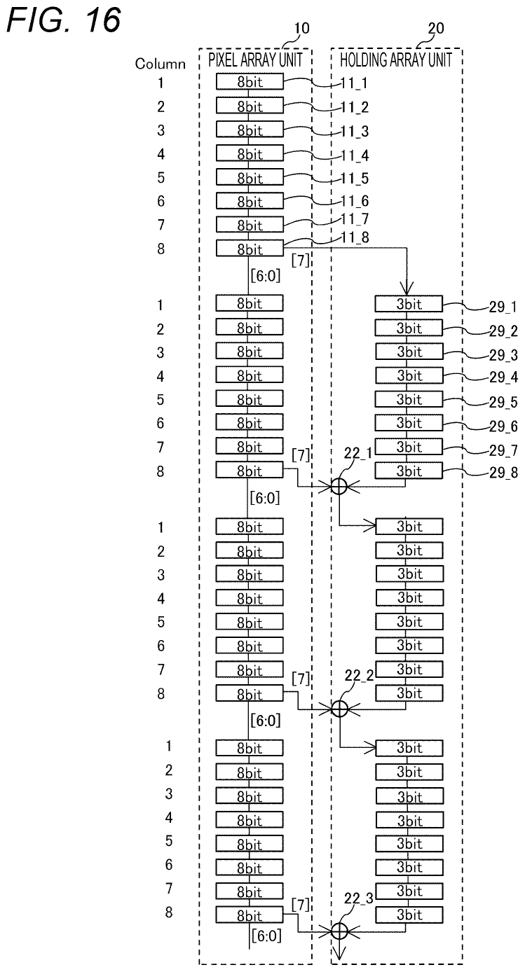

FIG. 16 is a circuit diagram illustrating a circuit configuration example of the pixel array unit 10 and the holding array unit 20 according to the sixth embodiment of the present technology. FIG. 16 illustrates a circuit example in which the bit length of the pixel circuit 11 is set to 8 bits, and one pixel unit is configured by eight-stage (N=8) pixel circuits 11_1 to 11_8. In the holding array unit 20, eight stages of 3-bit most significant bit holding units 29_1 to 29_8 are arranged corresponding to the eight-stage pixel circuits 11_1 to 11_8.

In the pixel array unit 10, under the control of the control unit 30, the count value of the most significant (MSB) bit is read from one pixel unit to the outside, and the remaining bits are sent to the pixel unit (counter) of the next stage. Note that a readout holding circuit that holds the count value of the most significant bit may be provided in one pixel unit, and the count value of the most significant bit may be read from the holding circuit.

A count value other than the read most significant bit among the count values in the final stage of each pixel unit is shifted to the counter in the first stage of the pixel unit in the next stage, and TDI processing (TDI operation) is performed continuously from the shifted value.

In the holding array unit 20, the count value of the most significant bit read from the pixel array unit 10 is shifted by the holding unit 29_1 to 29_8 of the most significant bit under the control of the control unit 30. Then, in the addition circuit 22_1, addition with the count value of the most significant bit read from the pixel unit of the next stage is performed, and the addition is used as an input of the holding unit of the next stage.

By the above-described operation, the holding array unit 20 performs an operation equivalent to counting of the most significant bit. Then, the count value of the lower bit read from the pixel array unit 10 in the final stage and the count value of the most significant bit shifted by the holding array unit 20 are added by the addition circuit 22_1 to obtain a total count value.

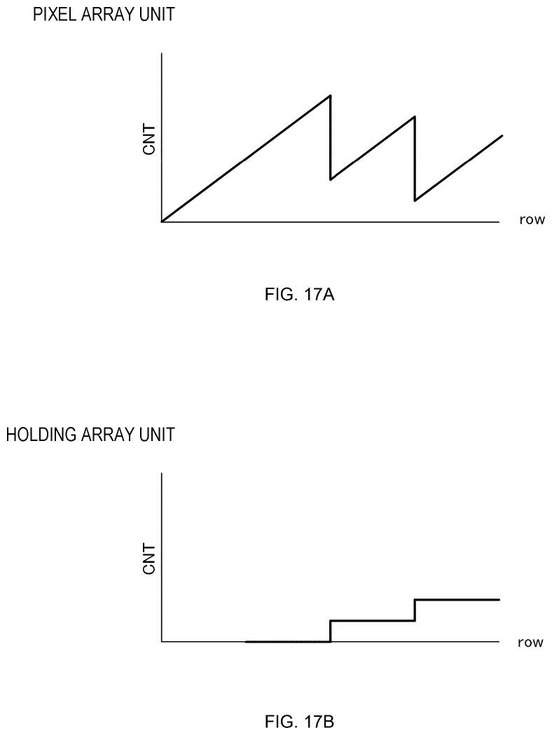

FIG. 17 is a diagram illustrating a relationship of the count value CNT with respect to the pixel row rou according to the sixth embodiment of the present technology. a of FIG. 17 indicates the relationship of the count value CNT with respect to the pixel row rou in the pixel array unit 10, and b of the drawing indicates the relationship of the count value CNT with respect to the pixel row rou in the holding array unit 20.

As described above, in the sixth embodiment of the present technology, the most significant bit of one pixel unit of the pixel array unit 10 is read to the holding array unit 20, and the remaining bits are sent to the counter of the pixel unit of the next stage. Then, the holding array unit 20 performs processing of obtaining a total count value from the count value of the most significant bit counted by the holding unit and the value of the lower bit shifted to the pixel unit of the next stage. As a result, basically, TDI processing similar to the case of the first embodiment can be executed. Furthermore, according to the sixth embodiment, it is possible to reduce the bit length read from the pixel array unit 10 and reduce the number of circuits in the holding array unit 20.

### 7. Seventh Embodiment

The seventh embodiment of the present technology is an example in which the count value of the most significant bit of one pixel unit is read to the outside, and the count values of all the bits are sent to the next-stage counter.

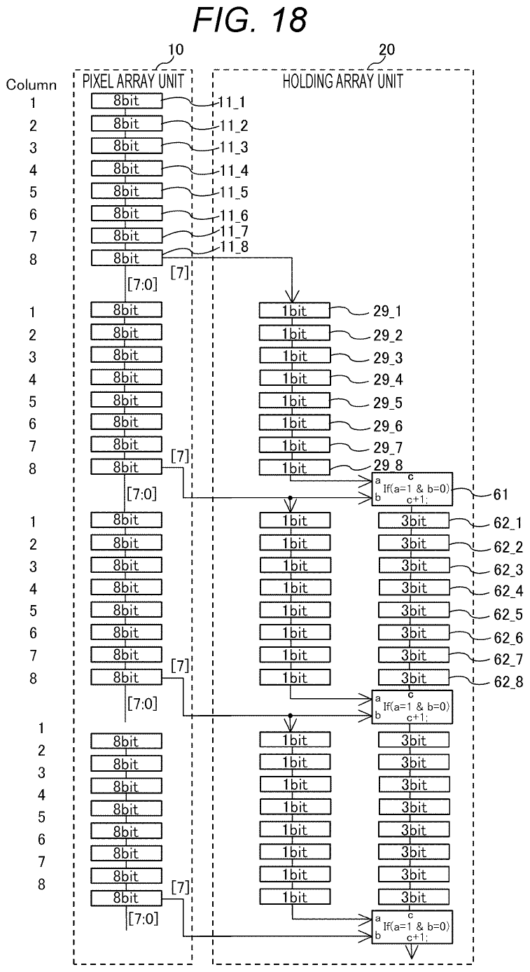

FIG. 18 is a circuit diagram illustrating a circuit configuration example of the pixel array unit 10 and the holding array unit 20 according to the seventh embodiment of the present technology. FIG. 18 illustrates a circuit example in which the bit length of the pixel circuit 11 is set to 8 bits, and one pixel unit is configured by 8-stage (N=8) pixel circuits 11_1 to 11_8. In the holding array unit 20, eight stages of 1-bit most significant bit holding units 29_1 to 29_8 are arranged corresponding to the eight-stage pixel circuits 11_1 to 11_8. In the holding array unit 20, an overflow determination circuit 61 and overflow count holding units 62_1 to 62_8 for 3-bit are further arranged.

In the pixel array unit 10, under the control of the control unit 30 illustrated in FIG. 1, the count value of the most significant (MSB) bit is read from one pixel unit to the outside, and the remaining bits are sent to the pixel unit (counter) of the next stage. Note that a readout holding circuit that holds the count value of the most significant bit may be provided in one pixel unit, and the count value of the most significant bit may be read from the holding circuit.

The count value in the final stage of each pixel unit is directly shifted to the counter in the first stage of the pixel unit in the next stage, and the TDI processing (TDI operation) is continuously performed from the shifted value.

In the holding array unit 20, under the control of the control unit 30 illustrated in FIG. 1, the count value a of the most significant bit read from the pixel array unit 10 is shifted by the holding unit 29_1 to 29_8 of the most significant bit. Then, after the comparison with the count value b of the most significant bit read from the pixel unit of the next stage is performed by the overflow determination circuit 61, in a case where there is a transition from 0 to 1 (a=1 & b=0), 1 is added to the overflow count holding units 62_1 to 62_8 and held. The overflow count holding units 62_1 to 62_8 also perform a shift operation similarly to the most significant bit holding unit 29_1 to 29_8.

By the above-described operation, in the holding array unit 20, an operation equivalent to the counting of the upper bits is performed. Then, a total count value is obtained by adding the count value of the lower bits read from the pixel array unit 10 in the final stage and the count value of the upper bits counted by the holding array unit 20.

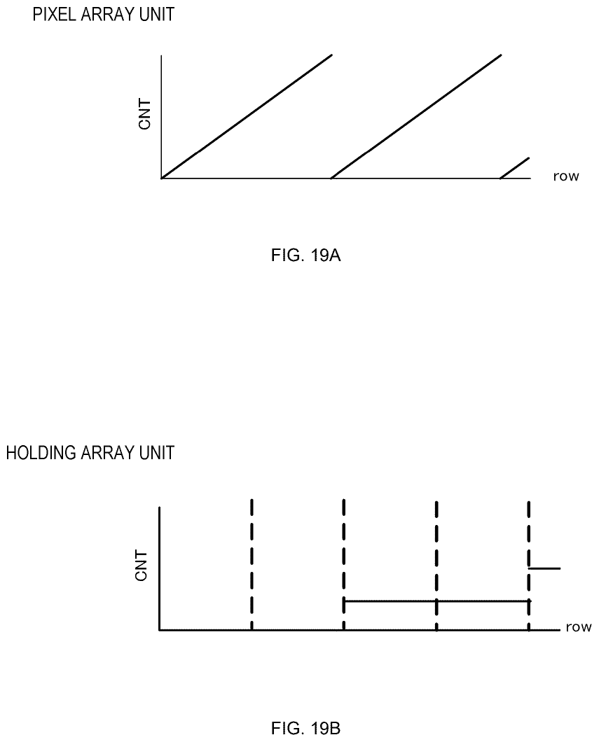

FIG. 19 is a diagram illustrating a relationship of the count value CNT with respect to the pixel row rou according to the seventh embodiment of the present technology. a of FIG. 19 indicates the relationship of the count value CNT with respect to the pixel row rou in the pixel array unit 10, and b of the drawing indicates the relationship of the count value CNT with respect to the pixel row rou in the holding array unit 20.

As described above, in the seventh embodiment of the present technology, in the pixel array unit 10, the most significant bit of one pixel unit is read to the holding array unit 20, and all bits are sent to the counter of the pixel unit of the next stage. Then, the holding array unit 20 performs processing of detecting overflow of the most significant bit and obtaining a total count value from the number of times of detection of overflow and the value of the lower bit shifted to the pixel unit of the next stage. As a result, basically, TDI processing similar to the case of the first embodiment can be executed. Furthermore, according to the seventh embodiment, similarly to the sixth embodiment, it is possible to reduce the bit length read from the pixel array unit 10 and reduce the number of circuits in the holding array unit 20.

### 8. Modification

Note that the above-described embodiments illustrate examples for embodying the present technology, and the matters in the embodiments and the matters specifying the invention in the claims have a correspondence relationship. Similarly, the matters specifying the invention in the claims and the matters in the embodiments of the present technology denoted by the same names as the matters specifying the invention have a correspondence relationship. However, the present technology is not limited to the embodiments, and can be embodied by making various modifications to the embodiments without departing from the gist thereof.

### 9. Application Example

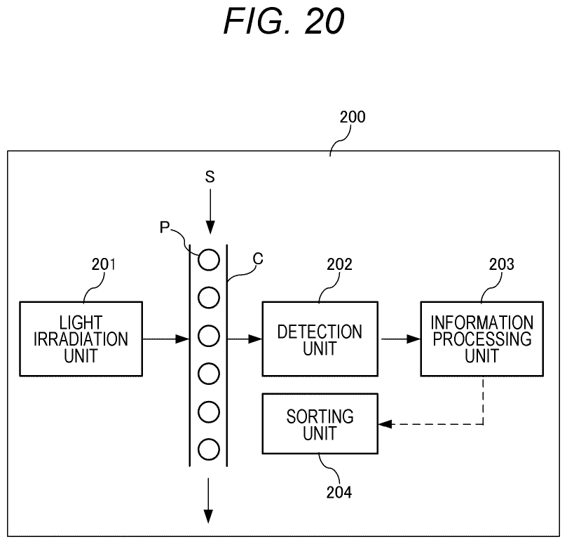

FIG. 20 is a diagram illustrating a schematic configuration example of a biological sample analysis apparatus 200 according to an application example of the present technology. The biological sample analysis apparatus 200 is an example of an electronic device of the present technology. The photodetection apparatus 1 of the present technology can be used for a detection unit 202 described later in the biological sample analysis apparatus 200.

The biological sample analysis apparatus 200 includes a light irradiation unit 201 that irradiates the biological sample S flowing through the flow channel C with light, a detection unit 202 that detects light generated by irradiating the biological sample S with light, and an information processing unit 203 that processes information regarding the light detected by the detection unit 202.

Examples of the biological sample analysis apparatus 200 include a flow cytometer and an imaging cytometer. The biological sample analysis apparatus 200 may include a sorting unit 204 that sorts a specific bioparticle P in the biological sample S. An example of the biological sample analysis apparatus 200 including the sorting unit 204 can include a cell sorter.

### (Biological Sample)

The biological sample S may be a liquid sample containing the bioparticle P. The bioparticle P is, for example, a cell or a non-cellular bioparticle. The above-described cells may be living cells, and more specific examples thereof include blood cells such as red blood cells and white blood cells, and germ cells such as sperm and fertilized eggs. In addition, the above-described cells may be directly collected from a specimen such as whole blood, or may be cultured cells acquired after culturing. Examples of the above-described non-cellular bioparticle include extracellular vesicles, particularly exosomes and microvesicles, The bioparticle P may be labeled with one or more labeling substances (for example, a dye (particularly, a fluorescent dye), a fluorochrome-labeled antibody, and the like). Note that particles other than the bioparticle P may be analyzed by the biological sample analysis apparatus of the present technology, or beads or the like may be analyzed for calibration or the like.

### (Flow Channel)

The flow channel C is configured such that the biological sample S flows. In particular, the flow channel C can be configured such that a flow in which the bioparticles P contained in the biological sample S are arranged in a substantially line is formed. The flow channel structure including the flow channel C may be designed such that a laminar flow is formed. In particular, the flow channel structure is designed such that a laminar flow in which the flow of the biological sample S (sample flow) is wrapped by the flow of the sheath liquid is formed. The design of the flow channel structure may be appropriately selected by those skilled in the art, and a known flow channel structure may be adopted. The flow channel C may be formed in a flow channel structure such as a microchip (chip having a flow channel on the order of micrometers) or a flow cell. The width of the flow channel C is 1 mm or less, and may be particularly 10 μm or more and 1 mm or less. The flow channel C and the flow channel structure including the flow channel C may be constituted by a material such as plastic or glass.

The biological sample analysis apparatus 200 is configured such that the biological sample S flowing in the flow channel C, particularly, the bioparticle P in the biological sample S is irradiated with light from the light irradiation unit 201. The biological sample analysis apparatus 200 may be configured such that the light interrogation point with respect to the biological sample S is located in the flow channel structure in which the flow channel C is formed, or may be configured such that the light interrogation point is located outside the flow channel structure. As an example of the former, a configuration in which the flow channel C in the microchip or the flow cell is irradiated with the above-described light can be mentioned. In the latter, the bioparticle P after exiting from the flow channel structure (particularly, the nozzle portion thereof) may be irradiated with the above-described light, and examples thereof include a flow cytometer of a jet in air system.

(light Irradiation Unit)

The light irradiation unit 201 includes a light source unit that emits light and a light guide optical system that guides the light to an interrogation point. The above-described light source unit includes one or a plurality of light sources. The type of the light source is, for example, a laser light source an LED. The wavelength of the light emitted from each light source may be any wavelength of ultraviolet light, visible light, or infrared light. The light guiding optical system includes, for example, an optical component such as a beam splitter group, a mirror group, or an optical fiber. Furthermore, the light guide optical system may include a lens group for condensing light, and includes, for example, an objective lens, The interrogation point at which the biological sample and the light intersect may be one or more. The light irradiation unit 201 may be configured to condense light emitted from one or a plurality of different light sources with respect to one interrogation point.

### (Detection Unit)

The detection unit 202 includes at least one photodetector that detects light generated by irradiating the bioparticle P with light. The light to be detected is, for example, fluorescence or scattered light (for example, any one or more of forward scattered light, backward scattered light, and side scattered light). Each photodetector includes one or more light receiving elements, for example, a light receiving element array. Each photodetector may include one or a plurality of photomultipliers (PMTs) and/or photodiodes such as APD and MPPC as a light receiving element. The photodetector includes, for example, a PMT array in which a plurality of PMTs is arranged in a one-dimensional direction. Furthermore, the detection unit 202 may include an imaging element such as a CCD or a CMOS, The detection unit 202 can acquire an image of the bioparticle P (for example, a bright-field image, a dark-field image, a fluorescence image, and the like) by the imaging element.

The detection unit 202 includes a detection optical system that causes light having a predetermined detection wavelength to reach a corresponding photodetector. The detection optical system includes a spectroscopic unit such as a prism or a diffraction grating, or a wavelength separation unit such as a dichroic mirror or an optical filter. For example, the detection optical system is configured to disperse light generated by irradiating the bioparticle P with light, and the dispersed light is detected by a plurality of photodetectors in which the number of the fluorescent dyes labeled with the bioparticle P is larger. A flow cytometer including such a detection optical system is referred to as a spectral-type flow cytometer. Furthermore, the detection optical system is configured to separate light corresponding to a fluorescence wavelength region of a specific fluorescent dye from light generated by irradiating the bioparticle P with light, for example, and cause a corresponding photodetector to detect the separated light.

In addition, the detection unit 202 may include a signal processing unit that converts the electric signal obtained by the photodetector into a digital signal. The signal processing unit may include an A/D converter as an apparatus that performs the conversion. The digital signal obtained by the conversion by the signal processing unit can be transmitted to the information processing unit 203. The above-described digital signal can be handled as data related to light (hereinafter also referred to as “optical data”) by the information processing unit 203. The above-described optical data may be, for example, optical data including fluorescence data. More specifically, the above-described optical data may be light intensity data, and the light intensity may be light intensity data (feature amounts such as Area, Height, and Width may be included) of light including fluorescence.

### (Information Processing Unit)

The information processing unit 203 includes, for example, a processing unit that executes processing of various data (for example, optical data) and a storage unit that stores various data. In a case of acquiring the optical data corresponding to the fluorescent dye from the detection unit 202, the processing unit can perform fluorescence leakage correction (compensation processing) on the light intensity data. In addition, in the case of the spectral-type flow cytometer, the processing unit performs fluorescence separation processing on the optical data and acquires light intensity data corresponding to the fluorescent dye.

The above-described fluorescence separation processing may be performed according to, for example, an unmixing method described in JP 2012232259 A. In a case where the detection unit 202 includes an imaging element, the processing unit may acquire the morphological information of the bioparticle on the basis of the image acquired by the imaging element. The storage unit may be configured to be able to store the acquired optical data. The storage unit may be further configured to be able to store spectral reference data used in the above-described unmixing processing.

In a case where the biological sample analysis apparatus 200 includes the sorting unit 204 to be described later, the information processing unit 203 can determine whether to sort the bioparticle P on the basis of the optical data and/or the morphological information. Then, the information processing unit 203 controls the sorting unit 204 on the basis of the result of the determination, and the bioparticle P can be sorted by the sorting unit 204.

The information processing unit 203 may be configured to be able to output various data (for example, optical data and images). For example, the information processing unit 203 can output various data (for example, two-dimensional plots, spectral plots, and the like) generated on the basis of the optical data. Furthermore, the information processing unit 203 may be configured to be able to receive inputs of various data, and for example, receives gating processing on a plot by the user. The information processing unit 203 can include an output unit (for example, a display or the like) or an input unit (for example, a keyboard or the like) for executing the output or the input.

The information processing unit 203 may be configured as a general-purpose computer, and may be configured as an information processing apparatus including, for example, a CPU, a RAM, and a ROM. The information processing unit 203 may be included in a housing provided with the light irradiation unit 201 and the detection unit 202, or may be outside the housing. Furthermore, various processes or functions by the information processing unit 203 may be realized by a server computer or a cloud connected via a network.

### (Sorting Unit)

The sorting unit 204 executes sorting of the bioparticle P according to the determination result by the information processing unit 203. The sorting method may be a method in which droplets containing bioparticles are generated by vibration, charges are applied to the droplets to be sorted, and the traveling direction of the droplets is controlled by an electrode. The method of sorting may be a method of controlling the traveling direction of the bioparticle P in the flow channel structure to perform sorting. The flow channel structure is provided with, for example, a control mechanism by pressure (injection or suction) or charge, Examples of the flow channel structure include a chip (for example, a chip described in Japanese Patent Application Laid-Open No. 2020-76736) having a flow channel structure in which the flow channel C branches into a collection flow channel and a waste liquid flow channel on the downstream side thereof, and a specific bioparticle is collected into the collection flow channel.

In the above-described application example, the biological sample analysis apparatus 200 has been described as an example of the electronic device of the present technology, but the electronic device of the present technology is not limited to the biological sample analysis apparatus 200.

### 10. Configuration That can be Taken by Present Technology

Note that the present technology can also have the following configurations.
(1) A photodetection apparatus including:
a pixel array unit in which pixel circuits each including a photon detection unit that generates a pulse signal in response to incidence of photons and a counter that counts the pulse signal generated by the photon detection unit are arranged in a matrix form, and the pixel circuits constitute a pixel unit with N stages (N is an integer) as one unit for each pixel column;
a holding array unit that is provided outside the pixel array unit and holds a count value of the counter read from the pixel unit; and
a control unit that performs a shift operation of writing a count value of the counter in a preceding stage to the counter in a next stage before exposure of a next line is started in the pixel unit and reads a count value of the counter for each pixel unit in units of M (M is an integer) pixel units from the pixel array unit to the holding array unit,
in which
the holding array unit includes:
(M-1) holding units each of which is provided corresponding to a pixel column of the pixel array unit and includes a holding unit at N stages that holds a count value of the counter read from one pixel unit of the M pixel units; and
(M-1) addition circuits that add a held value of a holding unit at a final stage in the holding unit at the N stages and a count value of the counter read from a pixel unit at a next stage of the one pixel unit.
(2) The photodetection apparatus according to (1), in which
a bit length of the counter of each stage of the pixel array unit includes a bit length set on the basis of a maximum value of the counter of a first stage and the number of stages in the one unit.
(3) The photodetection apparatus according to (1), in which
each pixel unit of the M pixel units includes a readout holding circuit that holds a count value of the counter read under control of the control unit, and
the control unit sequentially reads the count value of the counter from the readout holding circuit.
(4) The photodetection apparatus according to (3), further including
a common reading line for each pixel unit of the M pixel units, in which
the control unit sequentially reads the count value of the counter from the readout holding circuit of each pixel unit of the M pixel units to the common reading line.
(5) The photodetection apparatus according to (3), further including
a reading line for each pixel unit of the M pixel units, in which
each pixel unit of the M pixel units includes a parallel-serial conversion unit that performs parallel-serial conversion on the count value of the counter held in the holding array unit, and
the control unit performs control to read a value parallel-serially converted by the parallel-serial conversion unit to the reading line corresponding.
(6) The photodetection apparatus according to (1), in which
each pixel unit of the M pixel units includes a photon detection unit for blanking that does not perform exposure and a readout holding circuit as the pixel circuit of the final stage, and
the control unit performs control to read the count value held in the readout holding circuit to the holding array unit.
(7) The photodetection apparatus according to (1), in which
the holding unit at the N stages in the holding unit includes a shift register, and performs a shift operation at a same timing as a shift operation in the pixel unit.
(8) The photodetection apparatus according to (1), in which
the holding unit includes N-stage memories and a multiplexer that selects one of the N-stage memories, and
the multiplexer sequentially selects the N-stage memories in synchronization with a shift of a reading row of the pixel unit.
(9) The photodetection apparatus according to (1), in which
the control unit reads only a count value of a most significant bit of the pixel unit in the pixel array unit, shifts a count value of bits other than the most significant bit to a pixel unit of a next stage, and obtains a total count value from the count value of the most significant bit counted by the holding unit and a value of a lower bit shifted to the pixel unit of the next stage in the holding array unit.
(10) The photodetection apparatus according to (1), in which
the control unit reads only a count value of a most significant bit of the pixel unit in the pixel array unit, shifts count values of all bits to the pixel unit of the next stage, detects overflow of the most significant bit in the holding array unit, and obtains a total count value from the number of times of overflow detection and a value of a lower bit shifted to the pixel unit of the next stage.
(11) The photodetection apparatus according to any one of (1) to (10), in which
the holding array unit is disposed outside a semiconductor substrate on which the pixel array unit is formed.
(12) The photodetection apparatus according to any one of (1) to (10), in which
the holding array unit is disposed within a semiconductor substrate on which the pixel array unit is formed.
(13) The photodetection apparatus according to any one of (1) to (10), further including
a laminated chip structure in which at least two semiconductor substrates are laminated, in which
the photon detection unit in the pixel array unit is arranged on an upper semiconductor substrate, and
the counter and the holding array unit in the pixel array unit are arranged on a lower semiconductor substrate.
(14) The photodetection apparatus according to any one of (1) to (10), in which
the light receiving unit of the photon detection unit includes an avalanche photodiode.

### REFERENCE SIGNS LIST

1 Photodetection apparatus
10 Pixel array unit
11_1 to 11_8 Pixel circuit
12 Photon detection unit
13 Counter
14, 16, 26_1 to 26_4 Memory
15 Blanking photon detection unit
17 Readout holding circuit
18 Parallel-serial conversion circuit (PS)
20 Holding array unit
21_1 to 21_4 Holding unit
22_1 to 22_3, 25, 27_1 to 27_4 Addition circuit
23_1 to 23_4 Serial-parallel conversion circuit (SP)
24_1 to 23 N D-type flip-flop
28 Multiplexer
29_1 to 29_8 Most significant bit holding unit
30 Control unit
40 Counter array unit
50 Reading line
61 Overflow determination circuit
62_1 to 62_8 Overflow count holding unit
120 Recharge control unit
121 Light receiving unit
122 Quenching unit
123 Waveform shaping unit
200 Biological sample analysis apparatus
201 Light irradiation unit
202 Detection unit
203 Information processing unit
204 Sorting unit
PU1 to PU4 Pixel unit
HU1 to HU3 Holding unit

1. A photodetection apparatus comprising:
a pixel array unit in which pixel circuits each including a photon detection unit that generates a pulse signal in response to incidence of photons and a counter that counts the pulse signal generated by the photon detection unit are arranged in a matrix form, and the pixel circuits constitute a pixel unit with N stages (N is an integer) as one unit for each pixel column;
a holding array unit that is provided outside the pixel array unit and holds a count value of the counter read from the pixel unit; and
a control unit that performs a shift operation of writing a count value of the counter in a preceding stage to the counter in a next stage before exposure of a next line is started in the pixel unit and reads a count value of the counter for each pixel unit in units of M (M is an integer) pixel units from the pixel array unit to the holding array unit,
wherein
the holding array unit includes:
(M-1) holding units each of which is provided corresponding to a pixel column of the pixel array unit and includes a holding unit at N stages that holds a count value of the counter read from one pixel unit of the M pixel units; and
(M-1) addition circuits that add a held value of a holding unit at a final stage in the holding unit at the N stages and a count value of the counter read from a pixel unit at a next stage of the one pixel unit.

2. The photodetection apparatus according to claim 1, wherein
a bit length of the counter of each stage of the pixel array unit includes a bit length set on a basis of a maximum value of the counter of a first stage and the number of stages in the one unit.

3. The photodetection apparatus according to claim 1, wherein
each pixel unit of the M pixel units includes a readout holding circuit that holds a count value of the counter read under control of the control unit, and
the control unit sequentially reads the count value of the counter from the readout holding circuit.

4. The photodetection apparatus according to claim 3, further comprising
a common reading line for each pixel unit of the M pixel units, wherein
the control unit sequentially reads the count value of the counter from the readout holding circuit of each pixel unit of the M pixel units to the common reading line.

5. The photodetection apparatus according to claim 3, further comprising
a reading line for each pixel unit of the M pixel units, wherein
each pixel unit of the M pixel units includes a parallel-serial conversion unit that performs parallel-serial conversion on the count value of the counter held in the holding array unit, and
the control unit performs control to read a value parallel-serially converted by the parallel-serial conversion unit to the reading line corresponding.

6. The photodetection apparatus according to claim 1, wherein
each pixel unit of the M pixel units includes a photon detection unit for blanking that does not perform exposure and a readout holding circuit as the pixel circuit of the final stage, and
the control unit performs control to read the count value held in the readout holding circuit to the holding array unit.

7. The photodetection apparatus according to claim 1, wherein
the holding unit at the N stages in the holding unit includes a shift register, and performs a shift operation at a same timing as a shift operation in the pixel unit.

8. The photodetection apparatus according to claim 1, wherein
the holding unit includes N-stage memories and a multiplexer that selects one of the N-stage memories, and
the multiplexer sequentially selects the N-stage memories in synchronization with a shift of a reading row of the pixel unit.

9. The photodetection apparatus according to claim 1, wherein
the control unit reads only a count value of a most significant bit of the pixel unit in the pixel array unit, shifts a count value of bits other than the most significant bit to a pixel unit of a next stage, and obtains a total count value from the count value of the most significant bit counted by the holding unit and a value of a lower bit shifted to the pixel unit of the next stage in the holding array unit.

10. The photodetection apparatus according to claim 1, wherein
the control unit reads only a count value of a most significant bit of the pixel unit in the pixel array unit, shifts count values of all bits to the pixel unit of the next stage, detects overflow of the most significant bit in the holding array unit, and obtains a total count value from the number of times of overflow detection and a value of a lower bit shifted to the pixel unit of the next stage.

11. The photodetection apparatus according to claim 1, wherein
the holding array unit is disposed outside a semiconductor substrate on which the pixel array unit is formed.

12. The photodetection apparatus according to claim 1, wherein
the holding array unit is arranged in a semiconductor substrate on which the pixel array unit is formed.

13. The photodetection apparatus according to claim 1, further comprising
a laminated chip structure in which at least two semiconductor substrates are laminated, wherein
the photon detection unit in the pixel array unit is arranged on an upper semiconductor substrate, and
the counter and the holding array unit in the pixel array unit are arranged on a lower semiconductor substrate,

14. The photodetection apparatus according to claim 1, wherein
the light receiving unit of the photon detection unit includes an avalanche photodiode.

15. An electronic device including a photodetection apparatus comprising:
a pixel array unit in which pixel circuits each including a photon detection unit that generates a pulse signal in response to incidence of photons and a counter that counts the pulse signal generated by the photon detection unit are arranged in a matrix form, and the pixel circuits constitute a pixel unit with N stages (N is an integer) as one unit for each pixel column;
a holding array unit that is provided outside the pixel array unit and holds a count value of the counter read from the pixel unit; and
a control unit that performs a shift operation of writing a count value of the counter in a preceding stage to the counter in a next stage before exposure of a next line is started in the pixel unit and reads a count value of the counter for each pixel unit in units of M (M is an integer) pixel units from the pixel array unit to the holding array unit,
wherein
the holding array unit includes:
(M-1) holding units each of which is provided corresponding to a pixel column of the pixel array unit and includes a holding unit at N stages that holds a count value of the counter read from one pixel unit of the M pixel units; and
(M-1) addition circuits that add a held value of a holding unit at a final stage in the holding unit at the N stages and a count value of the counter read from a pixel unit at a next stage of the one pixel unit.
